(19) United States
(12) Patent Application Publication
(10) Pub. No.: US 2023/0073069 A1
(43) Pub. Date: Mar. 9, 2023

(54) METHOD FOR ASSESSING A DOTTING OF A SURFACE

(71) Applicant: BASF COATINGS GMBH, Münster (DE)

(72) Inventors: Yevgen ZHMAYEV, Muenster (DE); Fatmir RAKA, Muenster (DE); Igor MILLBAIER, Muenster (DE)

(21) Appl. No.: 17/800,815

(22) PCT Filed: Feb. 16, 2021
(86) PCT No.: PCT/EP2021/053795

§ 371 Date: Aug. 18, 2022

(30) Foreign Application Priority Data
Feb. 21, 2020 (EP) 20158667.4

(51) Int. Cl. G01N 21/89

(52) U.S. Cl. CPC G01N 21/8914

(57) ABSTRACT

Disclosed herein is a method for assessing a dotting of a surface, comprising including the steps of gradually dotting the surface during a predetermined interval of time and capturing a plurality of images of the dotted surface during the predetermined time interval. Also disclosed herein is a computer program product for assessing a dotting of a surface.

### FIELD OF THE INVENTION

The invention relates to a method for assessing a dotting of a surface, comprising the steps of: gradually dotting the surface during a predetermined interval of time and capturing a plurality of images of the dotted surface during the predetermined time interval. The invention further relates to a computer program product for assessing a dotting of a surface.

### BACKGROUND

A surface may be gradually provided with a plurality of dots over time. Thus, an initially empty surface will be completely covered after a certain amount of time. The dots are stochastically distributed on the surface.

For instance, the surface may be dotted by droplets of a coating liquid which are deposited on the surface by spraying the coating liquid towards the surface. A coating surface being damaged by impacting projectiles, i.e. by stone chipping, is another example of a surface being dotted.

Of course, the time scales of the mentioned processes are very different. While a sprayed surface is completely covered after a relatively short time, completely covering a coating surface by impact damages requires a relatively long time. Apart from that, the processes are very similar.

Experimentally optimizing a spraying process or a coating resistance is a very elaborate and time consuming and, hence, an expensive task. Indeed, the corresponding processes may be simulated numerically, i.e. computational fluid dynamics (CFD) may be applied to a model of a physical spraying process. The results of a numeric simulation has to be compared, however, with the simulated physical result in order to back up the numeric simulation and increase a predictive power thereof.

### SUMMARY OF THE INVENTION

It is therefore an object of the invention to propose a method for assessing a dotting of a surface which assessment facilitates comparing a physical dotting process with a numeric simulation thereof. Another object of the invention is to provide a computer program product for assessing a dotting of a surface.

One aspect of the invention is a method for assessing a dotting of a surface. The method comprises the steps of gradually dotting the surface during a predetermined interval of time and capturing a plurality of images of the dotted surface during the predetermined time interval. The images are captured with a frequency in a range from 1000 images per second to 5000 images per second. The predetermined time interval is chosen significantly smaller than a time interval being required for the surface to be completely covered by dots. The method may be applied to different dotting processes.

According to the invention, the method comprises the further steps of successively processing the plurality of images and deriving at least one dotting parameter value from the processed plurality of images. The processing comprises an ordinary image processing and optimizes the captured images in order to facilitate deriving the at least one dotting parameter from the images.

Preferably, dotting the surface comprises covering the surface with a plurality of droplets of a liquid spray or chipping the surface with a plurality of projectiles. In the first case each droplet makes a dot on the surface, while the surface is gradually covered by a liquid, i.e. a coating liquid. In the second case each impact of a projectile makes a dot on the surface, while the surface is gradually damaged by the projectiles, i.e. by stone chipping.

In many embodiments processing an image comprises pre-processing the captured image and converting the pre-processed image into a binary image. The pre-processing may comprise modifying a contrast, a brightness, a sharpness, a color saturation and the like of the captured image. The binary image further facilitates recognizing the dots by means of a pattern recognition algorithm.

The pre-processed image is preferably converted both into a first binary image using a first higher sensitivity and into a second binary image using a second lower sensitivity. The higher sensitivity and the lower sensitivity correspond to different contrast, brightness, sharpness and color settings. Using a higher sensitivity increases an average dot diameter and a number of dots as compared with the original captured image. Using a lower sensitity decreases the average dot diameter and the number of dots as compared with the original captured image. Concerning the average dot diameter and the number of dots, the original captured image is between the first binary image and the second binary image. A difference between the number of dots of the first binary image and the number of dots in the second binary image corresponds to a number of small dots.

In other embodiments deriving the at least one dotting parameter value comprises combining a first dotting parameter value derived from the first binary image and a second dotting parameter value derived from the second binary image. As disadvantages of the lower sensitivity are compensated by advantages of the higher sensitivity and vice versa combining the first binary image and the second binary image reduces a loss of data due to the image processing.

Advantageously, successively processing the plurality of images comprises stopping processing when a number of dots in the second binary image is larger than a number of dots in the first binary image. This particular condition is met when an overlapping of dots exceeds a certain threshold. For instance, three overlapping dots appear in the first binary image as a single large dot with an irregular shape due to the higher sensitivity and in the second binary image as three small dots with regular shapes due to the lower sensitivity. Ignoring any captured image whose first and binary images meet the specified condition increases an accuracy of the at least one derived dotting parameter.

A number of dots or a number of small dots may be derived as the at least one dotting parameter value. The number of dots or the number of small dots indicates a total dot count or a total small dot count of the surface. The number of dots or the number of small dots first increases up to a certain point in time and then drops from the certain point in time.

Alternatively or additionally, an average dot diameter may be derived as the at least one dotting parameter value. The average dot diameter indicates a surface area being covered by a single average dot. The average dot diameter may increase over the time if the dot diameter increases over the time or decrease over the time if the dot diameter decreases over the time.

Still alternatively or additionally, a coverage percentage of the surface may be derived as the at least one dotting parameter value. The coverage percentage indicates a ratio between an area covered by the plurality of dots and an area of the surface. The coverage percentage increases as does the time, i.e. the longer the surface is dotted the more the surface is covered by the dots.

The at least one dotting parameter is advantageously derived for a plurality of different process parameter values. In case of a liquid spray covering the surface the different process parameter values comprise an angular speed of a spray nozzle, a feeding rate of a liquid fed to the spray nozzle and a flow of air shaping the liquid spray provided by the spray nozzle.

In a preferred embodiment, deriving the dotting parameter value comprises calculating an averaged dotting parameter value being averaged over an averaging time domain. Averaging the derived dotting parameter over the averaging time domain allows for a single value representation of the time-dependent dotting parameter value. The single value representation facilitates comparing two or more dotting parameter values which were derived for different process parameter values.

In another embodiment, deriving the dotting parameter value comprises calculating an averaged dotting parameter value, the averaging time domain, the averaging time domain being a later half of the time interval, a middle portion of 75% of the time interval or a middle portion of 80% of the time interval.

The later half of the time interval is used as the averaging time domain for the number of dots as the at least one dotting parameter value. Excluding images of the former half of the time interval ignores an unevitable large variability of the number of dots in the early images. Taking into account images of the later half of the time interval results in averaging over a time interval where a dot count is substantially constant over the time as an increase of the dots hitting the surface is approximately compensated by a corresponding increase overlapping dots on the surface, i.e. a corresponding increase of an agglomeration of dots.

The middle portion of 75% of the time interval is used as the averaging time domain for the average dot diameter as the at least one dotting parameter value. Excluding images of the initial 12.5% of the time interval ignores an unevitable large variability of the number of dots in the early images. Excluding images of the final 12.5% of the time ignores an increasing overlapping of dots in the late images and, consequently, an artificial increasing of the average dot diameter.

The middle portion of 80% of the time interval is used as the averaging time domain for the coverage percentage as the at least one dotting parameter value. Excluding images of the former 10% of the time interval ignores an unevitable large variability of the number of dots in the early images. Excluding images of the final 10% of the time ignores an increasing overlapping of dots in the late images and, consequently, a decreasing of the covering rate.

The derived at least one dotting parameter value may be used as an input and/or as a verification means for a numeric simulation. The derived dotting parameter value is used either to increase an accuracy of a numerical simulation of the dotting of the surface or to verify the accuracy and increase a predictive power of a numeric simulation of the dotting of the surface. The more accurate the numeric simulation is, i.e. the better the numeric simulation predicts reality, the more efficient the surface dotting configuration may be optimized. In case of a spraying process the surface dotting configuration comprises parameter values specifiying a spray nozzle, parameter values of the liquid formulation and parameter values of the spraying process which parameter values affect the dotting of the surface.

Another aspect of the invention is a computer program product for assessing a a dotting of a surface. The computer program product comprises a data carrier storing a program code to be executed by a processor. The data carrier may be used for installing the stored program code and/or for upgrading an installed program code with the stored program code.

According to the invention, the program code implements an inventive method. The stored program code enables an existing surface dotting assessment configuration for an increased efficiency and accuracy. The surface dotting assessment configuration may comprise a bell-shaped liquid spray configuration, a high-speed camera and a computer being connected to the camera and having a processor and an image processing software to be executed by the processor for processing images captured by the high-speed camera.

It is an essential advantage of the inventive method that the at least one derived dotting parameter value allows for easily comparing experimental results obtained by a physical process with theoretic results obtained by a numeric simulation. Thus, an accuracy and a predictive power of the numeric simulations may be increased which in turn allows for optimizing parameter values of the physical process at low expenses.

Further advantages and configurations of the invention become apparent from the following description and the enclosed drawings.

It shall be understood that the features described previously and to be described subsequently may be used not only in the indicated combinations but also in different combinations or on their own without leaving the scope of the present invention.

### BRIEF DESCRIPTION OF THE DRAWINGS

FIG. 1 schematically shows a schematic illustration of a lateral view of a dotting assessment configuration for carrying out a method according to a first embodiment of the invention;

FIG. 2 shows an image of a dotted surface, the image being captured early in the time interval;

FIG. 3 shows an image of the dotted surface, the image being captured late in the time interval;

FIG. 4 shows a flowchart of a step of image processing according to the first embodiment of the invention;

FIG. 5 shows a graph of a derived first dotting parameter value and a first averaging time domain;

FIG. 6 shows a graph of a derived second dotting parameter value and a second averaging time domain;

FIG. 7 shows a graph of a derived third dotting parameter value and a third averaging time domain;

FIG. 8 shows a graph of averaged first dotting parameter values for a first liquid and different process parameter values;

FIG. 9 shows a graph of averaged first dotting parameter values for a second liquid and different process parameter values;

FIG. 10 shows a graph of averaged second dotting parameter values for the first liquid and different process parameter values;

FIG. 11 shows a graph of averaged second dotting parameter values for the second liquid and different process parameter values;

FIG. 12 shows an image of a dotted surface, the image being captured in a method according to a second embodiment of the invention.

### DETAILED DESCRIPTION OF THE DRAWINGS

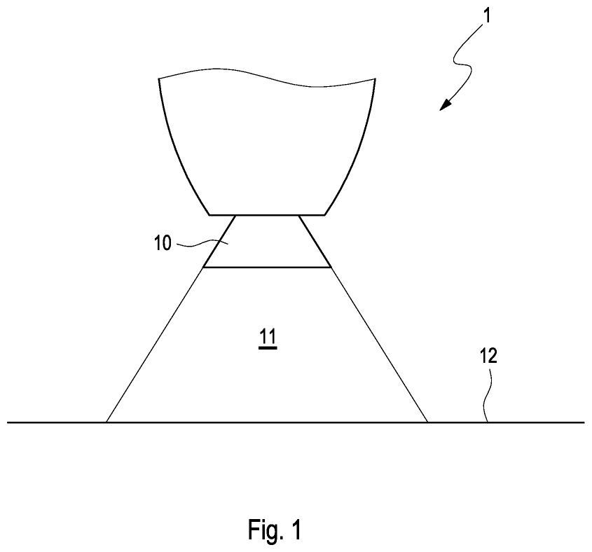

FIG. 1 schematically shows a schematic illustration of a lateral view of a surface dotting assessment configuration 1 for carrying out a method according to a first embodiment of the invention. The surface dotting configuration comprises a liquid spray configuration with a conical spray nozzle 10 for delivering a liquid spray 11. The surface dotting assessment configuration may be used, for instance, by a car manufacturer for applying a liquid coating onto a surface of a car body part (not shown).

Furthermore, the surface dotting assessment configuration comprises a surface 12 to be dotted which is provided as a transparent pane or the like and a high-speed camera (not shown) which is arranged opposite to the spray nozzle 10 with respect to the surface 12. The high-speed camera is oriented such that an optical axis of the high-speed camera extends towards the spray nozzle 10. The surface dotting assessment configuration may be used to assess a dotting of the surface 12.

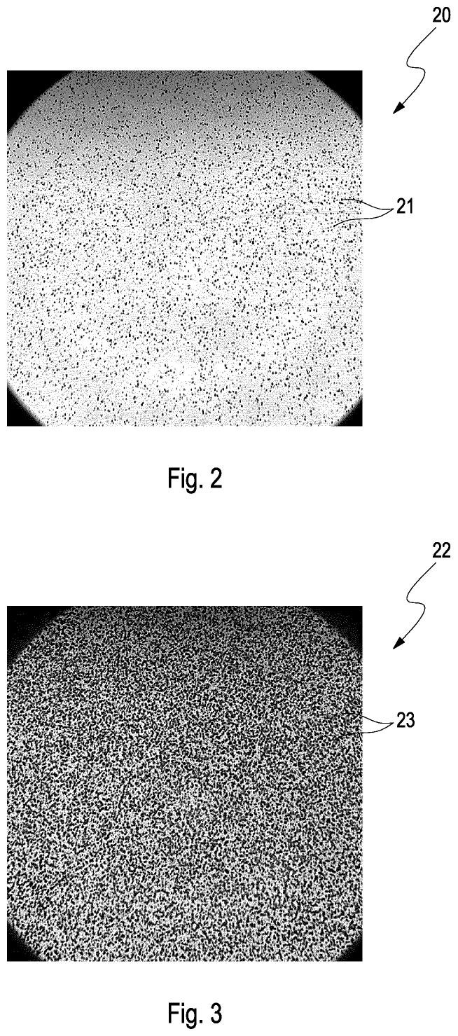

The bell-shaped liquid spray assessment configuration further comprises a computer (not shown). The computer has a processor and a memory comprising a program code, the program code implementing a method for assessing a dotting of the surface 12 and being executable by the processor. The program code may have been installed in the memory of the computer from a computer program product for assessing a dotting of the surface 12 according to the invention, the computer program product comprising a data carrier like a DVD or an USB stick storing the program code. The computer is connected to the high-speed camera for receiving one or more captured images 20, 22, 120 (see FIGS. 2, 3, 12) from the high-speed camera.

The surface dotting assessment configuration is configured for carrying out a method for assessing a dotting of the surface 12 according to the invention. The method comprises the following steps.

A liquid is fed to the spray nozzle 10 at a feeding rate and the spray nozzle 10 is rotated at an angular speed during a predetermined interval of time which is chosen to have 250 milliseconds (ms). Due to the operation of the spray nozzle 10 the surface 12 is gradually dotted by droplets of a liquid spray 11 delivered by the spray nozzle 10. Dotting the surface 12 comprises covering the surface 12 with a plurality of droplets each droplet creating a dot on the surface.

A plurality of images 20, 22, 122 of the dotted surface 12 is captured during the predetermined time interval.

FIG. 2 shows an image 20 of the dotted surface 12 which has been captured early in the time interval.

FIG. 3 shows an image 22 of the dotted surface 12 which has been captured late in the time interval.

The plurality of images 20, 22, 122 is successively processed. Processing an image 20, 22, 122 comprises pre-processing the captured image 20, 22, 122 by means of ordinary image processing, i.e. modifiying a contrast, a brightness, a sharpness, a color saturation and the like of the image 20, 22, 122, and converting the pre-processed image into a binary image 30, 31.

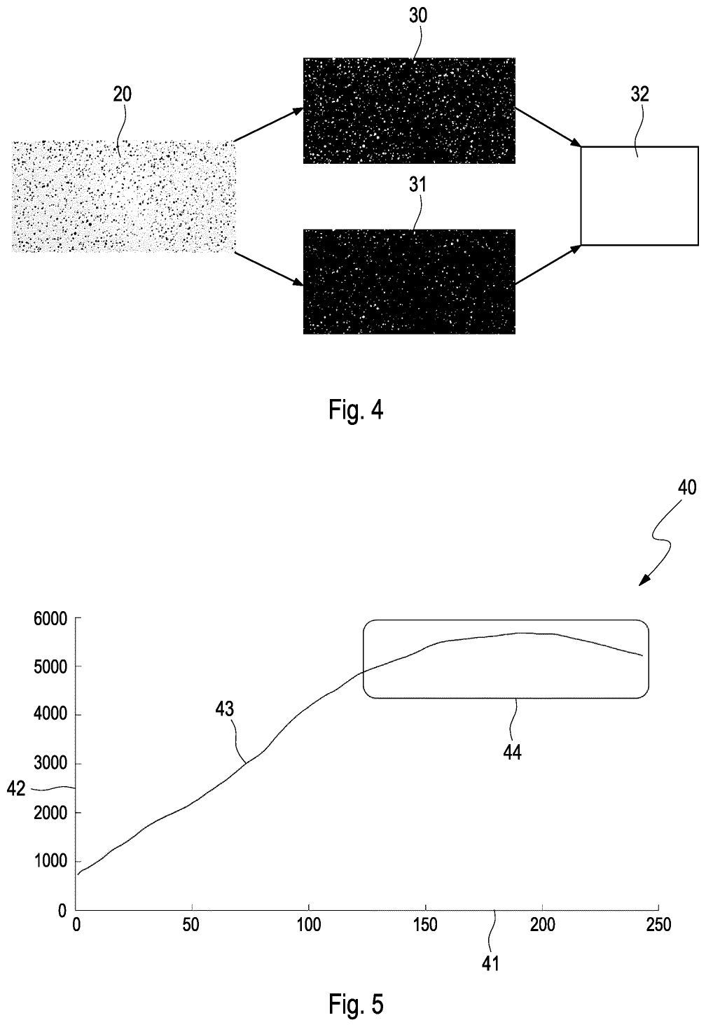

FIG. 4 shows a flowchart of a step of image processing according to the first embodiment of the invention.

The pre-processed image is converted both into a first binary image 30 using a first higher sensitivity and into a second binary image 31 using a second lower sensitivity.

In a further step at least one dotting parameter value 43, 53, 63, 73, 83, 93, 103 is derived from the processed plurality of images 30, 31, wherein a first dotting parameter value derived from the first binary image 30 and a second dotting parameter value derived from the second binary image 31 are combined to a combined dotting parameter value 32 representing the at least one dotting parameter value 43, 53, 63, 73, 83, 93, 103.

Successively processing the plurality of images 20, 22, 122 comprises stopping processing when a number of dots 21, 23, 121 in the second binary image 31 is larger than a number of dots 21, 23, 121 in the first binary image 30.

A number of dots 21, 23, 121 or a number of small dots 21, 23, 121 is derived as a first dotting parameter value 43.

FIG. 5 shows a graph 40 of the derived first dotting parameter value 43 and a first averaging time domain 44. The graph 40 has an abscissa 41 indicating a time in a range from 0 ms to 250 ms and an ordinate 42 indicating a number of dots 21, 23, 121 in a range from 0 to 6.000. The number of dots 21, 23, 121 is plotted as the first dotting parameter 43 dependent on the time. Apart from that, the later half of the time range defining the time interval is plotted as a first averaging time domain 44.

An average dot diameter is derived as a second dotting parameter value 53.

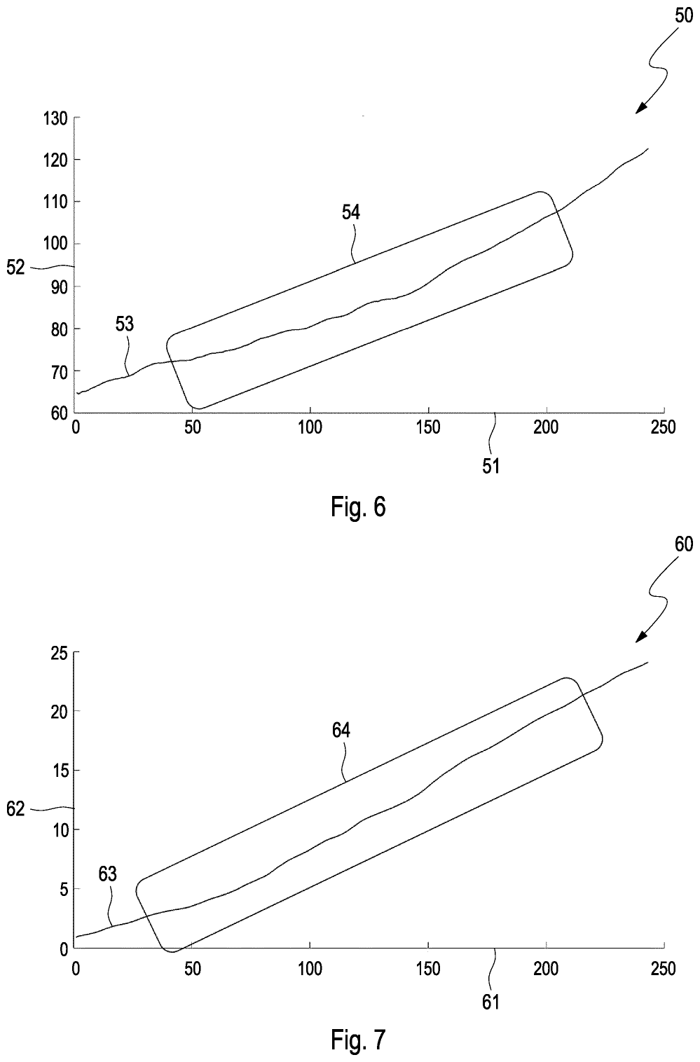

FIG. 6 shows a graph 50 of the derived second dotting parameter value 53 and a second averaging time domain 54. The graph 50 has an abscissa 51 indicating a time in a range from 0 milliseconds (ms) to 250 ms and an ordinate 52 indicating an average dot diameter in a range from 60 micrometer (μm) to 130 μm. The average dot diameter is plotted as the second dotting parameter 53 dependent on the time. Apart from that, a middle portion of 75% of the time range defining the time interval is plotted as a second averaging time domain 54.

A coverage percentage of the surface 12 is derived as a third dotting parameter value 63.

FIG. 7 shows a graph 60 of the derived third dotting parameter value 63 and a third averaging time domain 64. The graph 60 has an abscissa 61 indicating a time in a range from 0 milliseconds (ms) to 250 ms and an ordinate 62 indicating a coverage percentage of the surface in a range from 0 per cent (%) to 25%. The coverage percentage is plotted as the third dotting parameter 63 dependent on the time. Apart from that, a middle portion of 80% of the time range defining the time interval is plotted as a third averaging time domain 64.

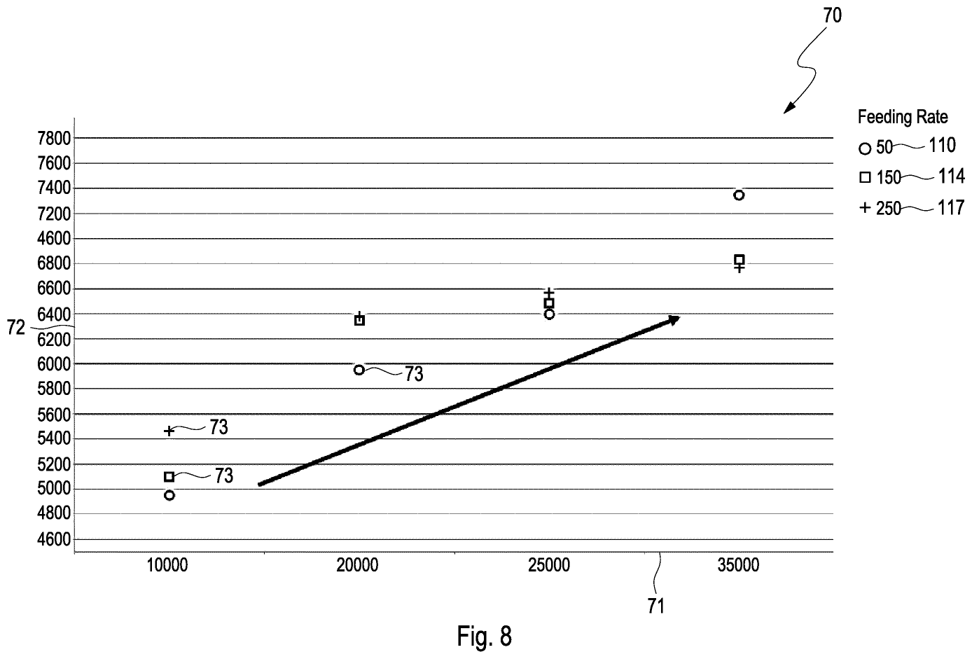

Deriving the dotting parameter value may comprise calculating an averaged dotting parameter value 73, 83, 93, 103 (see FIGS. 8, 9, 10, 11) over an averaging time domain 44, 54, 64. The averaging time domain 44, 54, 64 may be a later half of the time interval, a middle portion of 75% of the time interval or a middle portion of 80% of the time interval, respectively. Furthermore, each dotting parameter value 73, 83, 93, 103 may be derived for a plurality of different process parameter values 110, 111, 112, 113, 114, 115, 116, 117.

FIG. 8 shows a graph 70 of averaged first dotting parameter values 73 for a first liquid and different process parameter values 110, 114, 117. The graph 70 has an abscissa 71 indicating an angular speed of the spray nozzle 11 in a range from 10.000 rotations per minute (rpm) to 35.000 rpm and an ordinate 72 indicating an averaged number of dots 21, 23, 121 in a range from 4.600 to 7.800 for an acrylate as the first liquid. The averaged number of dots 21, 23, 121 is plotted as the averaged first dotting parameter value 73 for three different feeding rates each representing a process parameter value 110, 114, 117 of 50 milliliter per minute (ml/min), 150 ml/min and 250 ml/min, respectively. The averaged first dotting parameter value 73 increases with an increasing angular speed of the spray nozzle 10. The effect of the feeding rate 110, 114, 117 on the averaged first dotting parameter value 73 varies substantially dependent on the angular speed of the spray nozzle 10.

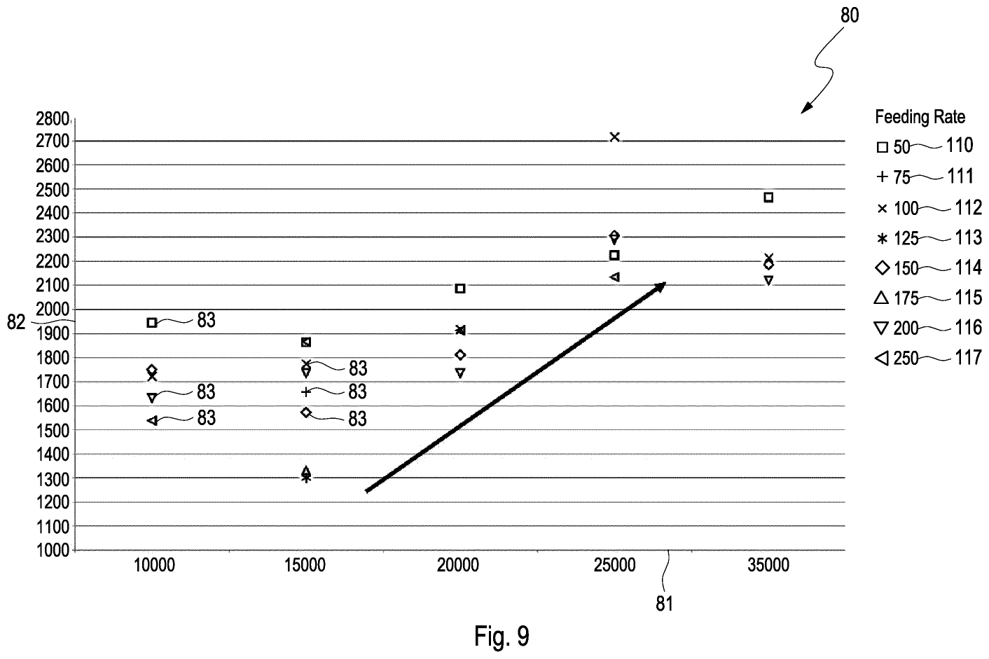

FIG. 9 shows a graph 80 of averaged first dotting parameter values 83 for a second liquid and different process parameter values 110, 111, 112, 113, 114, 115, 116, 117. The graph 80 has an abscissa 81 indicating a angular speed of the spray nozzle 11 in a range from 10.000 rotations per minute (rpm) to 35.000 rpm and an ordinate 82 indicating an averaged number of dots 21, 23, 121 in a range from 1.000 to 2.800 for an oil as the second liquid. The averaged number of dots 21, 23, 121 is plotted as the averaged first dotting parameter value 83 for eight different feeding rates each representing a process parameter value 110, 111, 112, 113, 114, 115, 116, 117 of 50 ml/min, 75 ml/min, 100 ml/min, 125 ml/min, 150 ml/min, 175 ml/min, 200 ml/min and 250 ml/min, respectively. The averaged first dotting parameter value 83 increases with an increasing angular speed of the spray nozzle 10. The effect of the feeding rate 110, 111, 112, 113, 114, 115, 116, 117 on the averaged first dotting parameter value 83 varies substantially dependent on the angular speed of the spray nozzle 10.

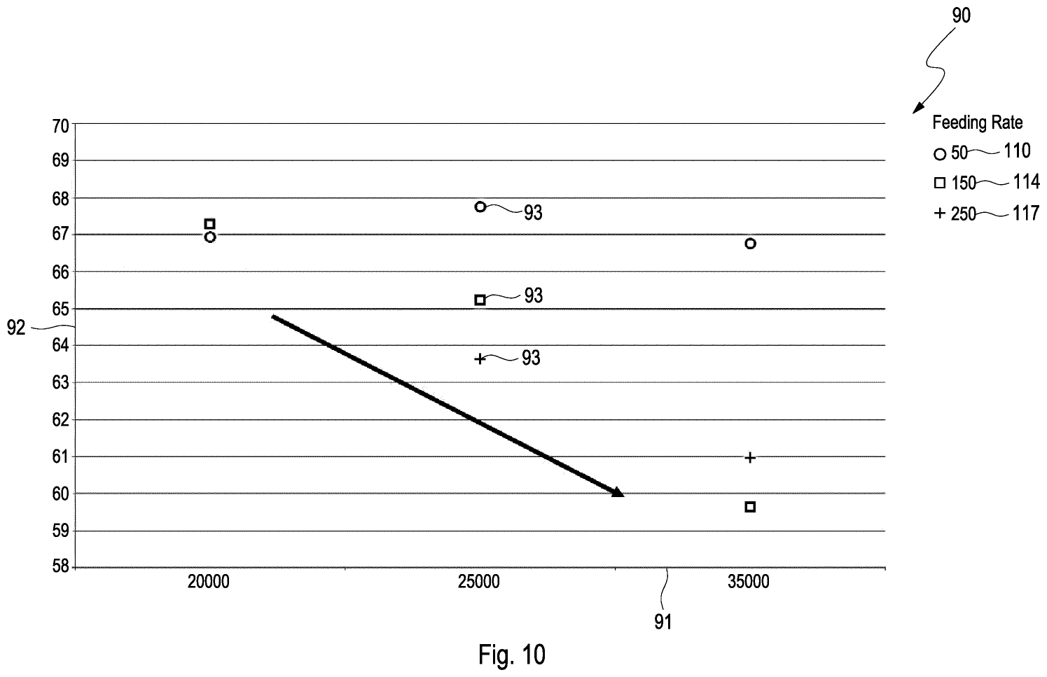

FIG. 10 shows a graph of averaged second dotting parameter values 93 for the first liquid and different process parameter values 110, 114, 117. The graph 90 has an abscissa 91 indicating an angular speed of the spray nozzle 11 in a range from 20.000 rotations per minute (rpm) to 35.000 rpm and an ordinate 92 indicating an averaged average dot diameter in a range from 58 μm to 70 μm for an acrylate as the first liquid. The averaged average dot diameter is plotted as the averaged second dotting parameter value 93 for three different feeding rates of the first liquid each representing a process parameter value 110, 114, 117 of 50 milliliter per minute (ml/min), 150 ml/min and 250 ml/min, respectively. The averaged second dotting parameter value 93 decreases with an increasing angular speed of the spray nozzle 10. The effect of the feeding rate 110, 114, 117 on the averaged second dotting parameter value 93 varies substantially dependent on the angular speed of the spray nozzle 10.

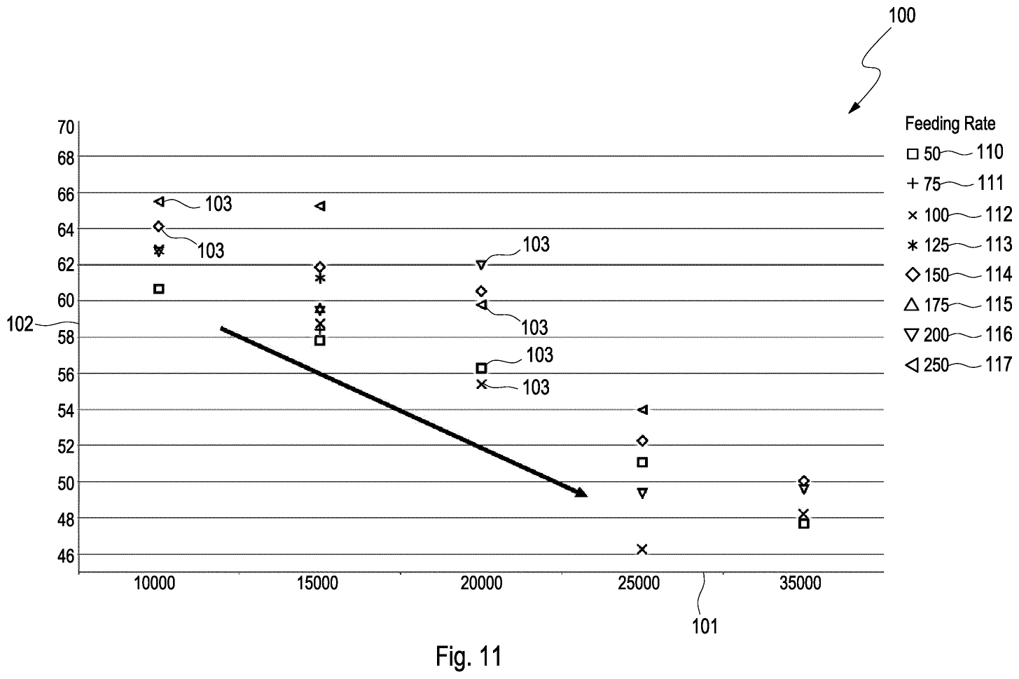

FIG. 11 shows a graph of averaged second dotting parameter values 103 for the second liquid and different process parameter values 110, 111, 112, 113, 114, 115, 116, 117. The graph 100 has an abscissa 101 indicating an angular speed of the spray nozzle 11 in a range from 10.000 rotations per minute (rpm) to 35.000 rpm and an ordinate 102 indicating an averaged average dot diameter in a range from 46 to 70 for an oil as the second liquid. The averaged average dot diameter is plotted as the averaged second dotting parameter value 103 for eight different feeding rates each representing a process parameter value 110, 111, 112, 113, 114, 115, 116, 117 of 50 ml/min, 75 ml/min, 100 ml/min, 125 ml/min, 150 ml/min, 175 ml/min, 200 ml/min and 250 ml/min, respectively. The averaged second dotting parameter value 103 increases with an increasing angular speed of the spray nozzle 10. The effect of the feeding rate 110, 111, 112, 113, 114, 115, 116, 117 on the averaged second dotting parameter value 103 varies substantially dependent on the angular speed of the spray nozzle 10.

The substantial variations of the derived first and second averaged dotting parameter values 73, 83, 93, 103 dependent on the angular speed of the spray nozzle 10 and differences related to the liquid sprayed by the nozzle 10 may be theoretically traced back to a plurality of dimensionless numbers which comprise a ratio of the respective viscosities, a ration of the respective surface tensions, a ratio of the centrifugal forces, a Reynolds number, a Weber number, a capillary number, a Laplace number and the like.

The derived at least one dotting parameter value 43, 53, 63, 73, 83, 93, 103 may be used as an input and/or as a verification means for a numeric simulation.

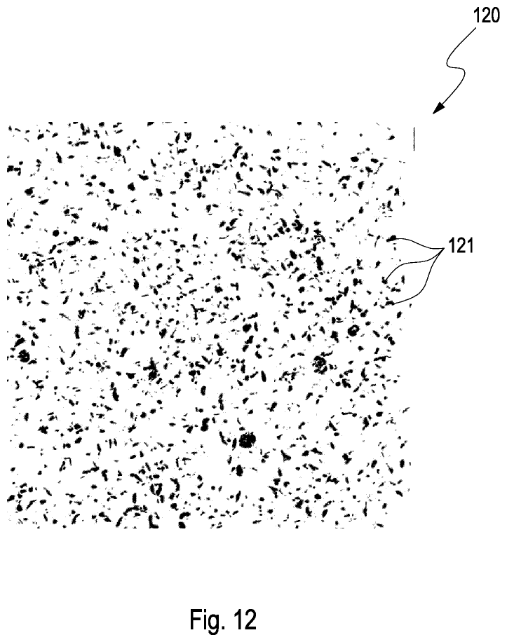

FIG. 12 shows an image 120 of a dotted surface 12, the image 120 being captured in a method according to a second embodiment of the invention. The image 120 comprises a plurality of dots 121 and shows a coated surface 12 which has been chipped by a plurality of projectiles, i.e. stones and the like, during an interval of time. Comparing the image 120 with the image 20 shown in FIG. 2 results in the insight that chipping and spraying may be assessed in the same way.

### REFERENCE NUMERALS

1 surface dotting assessment configuration

10 spray nozzle

11 liquid spray

12 surface

20 image, captured early

21 dot

22 image, captured late

23 dot

30 binary image, higher sensitivity

31 binary image, lower sensitivity

32 combined dotting parameter value

40 graph

41 abscissa

42 ordinate

43 first dotting parameter value

44 first averaging time domain

50 graph

51 abscissa

52 ordinate

53 second dotting parameter value

54 second averaging time domain

60 graph

61 abscissa

62 ordinate

63 third dotting parameter value

64 third averaging time domain

70 graph

71 abscissa

72 ordinate

73 averaged first dotting parameter value for a first liquid

80 graph

81 abscissa

82 ordinate

83 averaged first dotting parameter value for a second liquid

90 graph

91 abscissa

92 ordinate

93 averaged second dotting parameter value for the first liquid

100 graph

101 abscissa

102 ordinate

103 averaged second dotting parameter value for the second liquid

110 process parameter value

111 process parameter value

112 process parameter value

113 process parameter value

114 process parameter value

115 process parameter value

116 process parameter value

117 process parameter value

120 image

121 dot

1. A method for assessing a dotting of a surface, comprising the steps of:
gradually dotting the surface during a predetermined interval of time;
capturing a plurality of images of the dotted surface during the predetermined time interval;
successively processing the plurality of images; and
deriving at least one dotting parameter value from the processed plurality of images.

2. The method according to claim 1, wherein dotting the surface comprises covering the surface with a plurality of droplets of a liquid spray or chipping the surface with a plurality of projectiles.

3. The method according to claim 1, wherein processing an image comprises pre-processing the captured image and converting the pre-processed image into a binary image.

4. The method according to claim 3, wherein the pre-processed image is converted both into a first binary image using a first higher sensitivity and into a second binary image using a second lower sensitivity.

5. The method according to claim 4, wherein deriving the at least one dotting parameter value comprises combining a first dotting parameter value derived from the first binary image and a second dotting parameter value derived from the second binary image.

6. The method according to claim 4, wherein successively processing the plurality of images comprises stopping processing when a number of dots in the second binary image is larger than a number of dots in the first binary image.

7. The method according to claim 1, wherein a number of dots or a number of small dots is derived as the at least one dotting parameter value.

8. The method according to claim 1, wherein a dot diameter is derived as the at least one dotting parameter value.

9. The method according to claim 1, wherein a coverage percentage of the surface s derived as the at least one dotting parameter value.

10. The method according to claim 1, wherein the at least one dotting parameter is derived for a plurality of different process parameter values.

11. The method according to claim 1, wherein deriving the dotting parameter value comprises calculating an averaged dotting parameter value being averaged over an averaging time domain.

12. The method according to claim 1, wherein deriving the dotting parameter value comprises calculating an averaged dotting parameter value, the averaging time domain being a later half of the time interval, a middle portion of 75% of the time interval or a middle portion of 80% of the time interval.

13. The method according to claim 1, wherein the derived at least one dotting parameter value is used as an input and/or as a verification means for a numeric simulation.

14. The method according to claim 1, being executed by a processor executing a program code implementing the method.

15. A computer program product for assessing a dotting of a surface, comprising a data carrier storing a program code to be executed by a processor, the program code implementing a method according to claim 1.
